(19) United States
(12) Patent Application Publication
(10) Pub. No.: US 2007/0175905 A1
(43) Pub. Date: Aug. 2, 2007

(54) GAS STORAGE CONTAINER LININGS FORMED WITH CHEMICAL VAPOR DEPOSITION

(75) Inventors: Robert Torres JR., Parker, CO (US); Lawrence M. Wagg, Lafayette, CO (US); Joseph V. Vininski, Boulder, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Matheson Tri-Gas, Inc., Longmont, CO (US)

(21) Appl. No.: 11/564,181

(22) Filed: Nov. 28, 2006

Related U.S. Application Data
(60) Provisional application No. 60/740,399, filed on Nov. 28, 2005.

(51) Int. Cl. B05D 7/22; F17C 1/02

(52) U.S. Cl. 220/586; 427/230; 427/237

(57) ABSTRACT

A method of coating an interior of a gas storage container, where the method includes supplying a chemical vapor precursor to the storage container, and forming a metal coating on the interior surface of the container, where the coating is formed from the chemical vapor precursor. Also, a gas storage container that includes a gas storage vessel with an interior surface that has a liner formed on the interior surface of the storage vessel. The liner may include tungsten metal with a purity of about 99%, by weight, or more. Additionally, a system for making a metal lined gas storage container that may include a chemical vapor precursor generator, and a precursor injection assembly for transporting the precursor into a gas storage vessel. The system may also include an exhaust outlet for removing gaseous deposition products from the gas storage vessel.

### CROSS-REFERENCES TO RELATED APPLICATIONS

This application claims priority to U.S. Provisional application Ser. No. 60/740,399, filed Nov. 28, 2005, and titled “Gas Storage Container Linings Formed With Chemical Vapor Deposition”, the entire contents of which are herein incorporated by reference for all purposes.

### BACKGROUND OF THE INVENTION

Computer and electronics manufacturers are demanding increasingly pure process gases for semiconductor chip fabrications. This includes a demand for higher purity precursors used for doping, etching, and depositing chip components. When the precursors are corrosive, there is an additional challenge in preventing the corrosive materials from reacting with the storage container. For example, a corrosive precursor like hydrogen fluoride or hydrogen chloride can react with the inner walls of a standard carbon steel storage cylinder and contaminate the precursor.

One way to reduce this corrosion contamination is to make (or coat) the storage container with materials that do not react with the precursor. Carbon steel storage cylinders used to store hydrogen chloride, for example, may be coated on the inside with a non-reactive nickel layer. But conventional coating methods can leave defects in the coating where the reactive precursor can infiltrate the underlying substrate.

In electrolytic plating, for example, an open storage cylinder is filled with an aqueous solution of a dissolved metal salt. A voltage applied to the cylinder causes the metal ions in the solution to plate out as lining of the reduced metal on the inner surface of the cylinder. After the metal coating is formed and polished, the top may be heat forged or welded on the cylinder. The heat forging can put a lot of stress on the thin metal coating, creating defects that can be breached by the precursor. Corrosion products can seep back through the defective lining and contaminate the precursor.

Another coating method involves electroless plating of a lining on a finished storage cylinder. Because the cylinder is fully formed, there is no opportunity to form defects in the lining when the cylinder top is attached. But the lining formed with electroless plating is a compound or alloy that can still react with corrosive precursors. For example, electroless plating has been used to form nickel-phosphorous linings for hydrogen halide storage cylinders. The phosphorus in the lining can leach into the precursor, reducing its purity. The lining is also brittle and has very different thermal expansion characteristics than the underlying walls of the carbon steel cylinder. Cracks form easily in the lining, exposing the reactive carbon steel to the precursor.

The defects and impurities in the lining can contaminate the corrosive precursor to the extent that it becomes unusable for high-purity applications. The problem is growing with the development of more applications that require increasingly pure corrosive precursors. Thus, there is a need for new coating methods that can form inert storage container linings with significantly fewer defects and impurities. These methods, and the lined storage containers made by them, are addressed by the present invention.

### BRIEF SUMMARY OF THE INVENTION

Embodiments of the invention include a method of coating a storage container for a gas. The method may include the steps of supplying a chemical vapor precursor to an interior space of the storage container, and forming a metal coating on an interior surface that is exposed to the interior space of the storage container. The coating is formed from the chemical vapor precursor.

Embodiments of the invention also include a gas storage container that includes a gas storage vessel with an interior surface that can be exposed to a stored gas, and a liner formed on the interior surface of the storage vessel. The liner may include an metal or metal alloy with a purity of about 99%, by weight, or more.

Embodiments of the invention may still further include a system for making a metal lined gas storage container. The system may include a chemical vapor precursor generator to generate a chemical vapor precursor, and a precursor injection assembly for transporting the chemical vapor precursor into an interior space of a gas storage vessel. The system may also include an exhaust outlet for removing gaseous deposition products from the interior space of the gas storage vessel. The chemical vapor precursor forms the metal lining on an interior surface of the storage vessel.

Additional embodiments and features are set forth in part in the description that follows, and in part will become apparent to those skilled in the art upon examination of the specification or may be learned by the practice of the invention. The features and advantages of the invention may be realized and attained by means of the instrumentalities, combinations, and methods described in the specification.

### BRIEF DESCRIPTION OF THE DRAWINGS

FIG. 1 is a flowchart illustrating steps in a method of coating a gas storage container according to embodiments of the invention;

FIG. 2 is a simplified schematic of a system for forming metal lining in gas storage containers according to embodiments of the invention;

FIG. 3 is a simplified schematic of a system for circulating and recycling precursors used to form linings in gas storage containers according to embodiments of the invention; and

FIG. 4 shows NPT/NGT tap profile for gas cylinders according to embodiments of the invention.

### DETAILED DESCRIPTION OF THE INVENTION

Methods of forming low-defect, high-purity linings (i.e., coatings) for liquid and gas storage containers are described. The methods may include chemical vapor deposition processes (CVD) that deposit a lining on an interior surface of the storage container. The CVD processes can be done on an assembled storage container (e.g., a gas cylinder) to reduce defects in the lining caused by hot forging and other assembly steps. The processes can also use starting materials that leave fewer impurities in the lining, which reduces the contamination of the liquids and gases stored in the container. The starting materials may be selected to give a number of different qualities to the lining, including, but not limited to, corrosion protection, improved strength, shatter resistance, electrical conductance, electromagnetic reflectance, wear resistance, and/or friction resistance.

Examples include forming a metal lining on the interior surface of a carbon steel storage cylinder using metal-organic chemical vapor deposition (MOCVD). An organometallic chemical vapor precursor may be supplied to the cylinder under conditions that allow the metal substituent to deposit on the cylinder's interior surface to form the metal lining. The chemical vapor precursor and process conditions may be selected to form the metal lining with a metal purity of at least 90%, by wt.; 99%, by wt., (i.e., two-nines pure); 99.9%, by wt., (three-nines pure); 99.99%, by wt., (four-nines pure); 99.999%, by wt. (five-nines pure), or more. The organometallic precursor used to make the metal lining may give the cylinder high corrosion resistance to a corrosive liquid or gas.

The invention allows controlled deposition of metal coatings on the interior of complex shapes. Coatings may be uniform or of varying thickness, and selected areas may also be protected from deposition. Coatings can normally be applied as a final manufacturing step after all forming operations are complete, minimizing deformation and residual stresses in the metal coating.

The technology described herein has advantages over plating from electrochemical means since geometry of the electrode and substrate can offer very difficult configurations in which the deposition cannot occur uniformly or not at all. Electroless methods can conformally coat more intricate designs, but typically incorporate the chemical reducing agent into the deposited material.

The application of pure metal in configurations that are normally difficult to coat or plate by other means is of significant commercial value. Currently, there is a need in the semiconductor industry to utilize nickel lined cylinders for corrosive gas applications wherein the nickel content must be greater than 99% pure. Current means for manufacturing such cylinders are difficult and expensive since the plating must occur during the middle of the manufacturing process. The plated shells are then returned to the cylinder manufacturer for closing of the shell, and drill and tapping of the threads. During the neck down process, the nickel coating often delaminates due to the stress of the manufacturing process. In addition, the threaded area must be replated after drill and tap since the nickel coating gets removed during this process.

In embodiments of the method where a nickel lining is formed on a fully assembled gas cylinder has significant raw material and time savings compared to traditional methods of manufacturing. In addition, the defect ratio of the cylinders coated by directional chemical vapor deposition can be much lower than corresponding electrolytic nickel plated cylinders.

Exemplary Coating Method

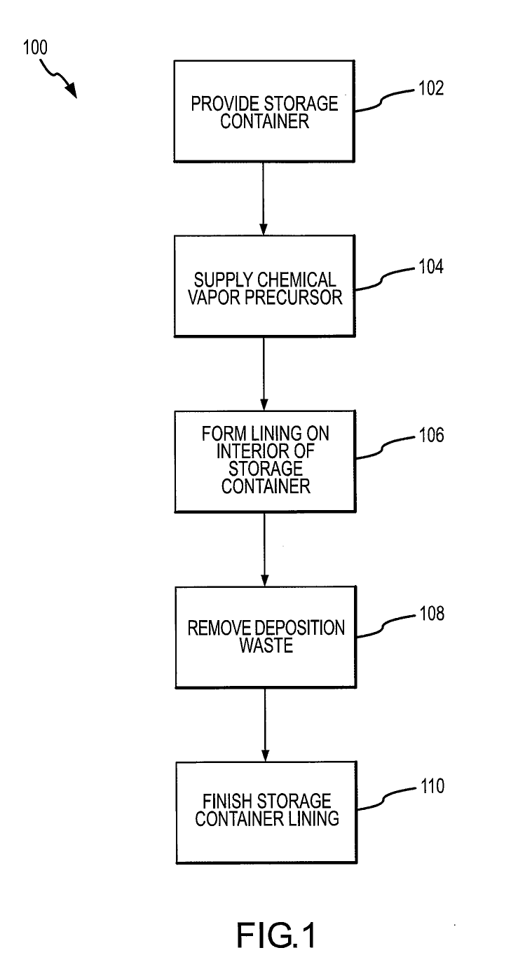

Referring now to FIG. 1, a flowchart illustrating steps in a method 100 of coating a gas storage container according to embodiments of the invention is shown. The method 100 includes providing a storage container 102 for coating. The storage containers may include liquid/gas storage cylinders made from carbon steel, iron, aluminum, etc. The cylinders may be assembled to the extent that a domed-shaped top portion has been hot forged, welded, soldered, bonded, and/or otherwise attached to the cylindrical cylinder body.

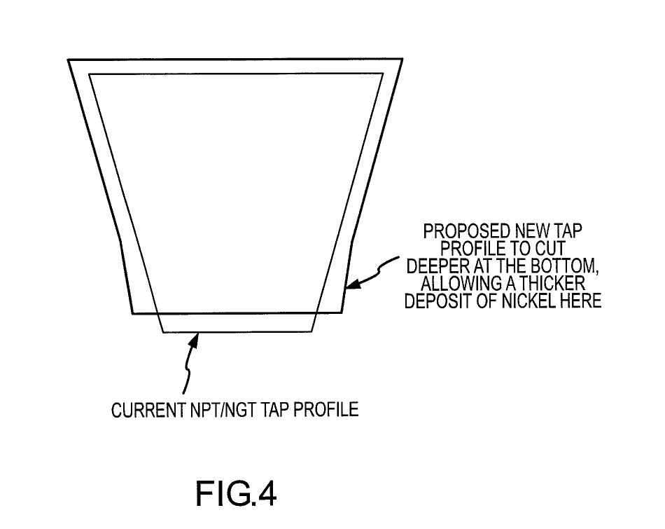

An opening may be formed (e.g., machined) in the top portion to accept a valve assembly that controls the release of fluids (i.e., liquids and gases) stored in the cylinder. A carbon steel tap may be used to thread the opening. The opening may be over threaded by driving the carbon steel tap further than necessary through the opening. After the threads have been coated with the lining material, the opening may be retapped to provide an adequate fit with a mating valve stem or other threaded objected. The coating in the threaded area may also be made thinner by controlling the flow rate of the chemical vapor precursor that contacts the threads. The flow rate may be controlled with a baffle that limits the access of the precursor to the threaded opening. In additional embodiments, a secondary tap, as shown in FIG. 4, may be used on the uncoated portions of the opening that are closer to straight than the NPT or NGT taper. This secondary tap can cut deeper at the bottom of the neck and leave more material at the top of the opening for mechanical integrity when retapping a bottom portion of the opening.

The interior surface of the storage container may be pretreated so the lining will better adhere to the container substrate. Pretreatment may include washing the interior surfaces of the container with a solvent wash to remove organic contaminants. Washings may also be done with acid solutions that remove oxide compounds from the container's interior surface.

The method 100 may also include supplying a chemical vapor precursor 104 to the storage container. Examples of chemical vapor precursors may include organometallic precursors that include an organic substituent and a metallic substituent wherein the organic substituent comprises methyl, ethyl, propyl, butyl, groups and the metallic substituent comprises nickel, gold, platinum, copper, titanium, lead, chromium, iron, tungsten, cobalt, and silver. Specific organometallic precursors include, for example, nickel carbonyl, tetraethyl lead, and dimethylaluminum hydride, among many other organometallic precursors. In addition, metallic substituents can be combined with halogen substituents to form precursors that decompose to form metals on the surface. Examples comprise the above listed metals with fluoride, chloride, bromides, iodides. Examples of molecules include, but are not limited to, NiCl₂, AsCl₃, AgBr, TiCl₄, and WF₆.

The chemical vapor precursor may be supplied from a pre-made source of precursor, or may be generated in situ during the deposition operation. For example, an organometallic precursor may be generated in situ by reacting a metal substrate with carbon-containing reactants. The metal substrate may include, for example, nickel, gold, platinum, copper, titanium, lead, chromium, iron, tungsten, cobalt, and/or silver, among other metals. The carbon-containing reactants may include, for example, a C₁₋₆ alkyl group, a CO group, and/or an aromatic group, among other reactants. Additional examples include supplying a metal halide chemical vapor precursor, such as NiCl₂, AsCl₃, AgBr, TiCl₄, and WF₆.

The chemical vapor precursor may be supplied to the storage container as a pure gas, or as a gas mixture that includes the precursor and non-reactive carrier gas. When a gas mixture is used, the partial pressures of the precursor and other gases may be controlled to keep the precursor concentration in a predefined range. The flow dynamics of the chemical vapor precursor in the storage container may also be controlled to keep the precursor supplied to all exposed areas of the container. This may include supplying the precursor through a perforated tube or distribution manifold that extends into the container. Precursor exiting the tube through the perforations can reach all areas of the interior container surface (especially the bottom of the container) at a more uniform flow rate.

A gas injection assembly may also be used that is inserted within the part to be coated, and designed so as to distribute gases within the part to coat different regions with varying thicknesses of metal. The temperature of the gas, the assembly manifold, and the part can also be independently controlled to obtain a uniform lining thickness. The assembly manifold can also include distribution lines for inert gases that can be used as a blanket to prevent lining deposition in localized areas, such as on the interior surface of transparent sight glasses on chemical reaction vessels. The chemical vapor precursor can also be controlled with laminar flow paths through various orifices. In addition, the precursor can be directed through various channels and restricting orifices to obtain directional control of the deposition.

For metal depositing precursors that decompose on exposure to elevated temperatures, the gas injection assembly may also include facilities to cool the manifold or the gas so as to prevent the deposition of metals on the manifold itself. Cooling may be achieved by, for example, cooling the precursor admitted to the manifold before admission so that the rate of heat transfer into the manifold is low enough that the gas does not significantly decompose before it exits the manifold. Cooling the precursor in the manifold may also be done by forced cooling of the manifold using a passage incorporated within the manifold for circulating chilled heat transfer fluid. Cooling may also be done by admitting the precursor to the manifold through a pressure reducing valve, such that the thermodynamic cooling of the expanding gas (known as the Joule-Thompson effect) cools the gas sufficiently that no deposition occurs on the gas distribution manifold. Additional methods may also be used to cool the precursor in the manifold.

The chemical vapor precursor may be deposited on the interior of the storage container to form the container lining 106. Deposition parameters that may be controlled to affect the purity, thickness, and other properties of the lining may include the chemical vapor precursor pressure (or partial pressure) in the storage container, the temperature of the interior surface of the container, and the flow rate of the precursor, among other conditions. The precursor can also be partially decomposed to form a charged species and the subsequent charged species can be directionally controlled through electric and magnetic means. The target substrate surface can also be controlled electrically or magnetically to control the area in which deposition occurs.

In addition to thermal methods used to decompose volatile metal containing species, other methods such as photo induced decomposition, magnetic field induced decomposition, and chemical induced decomposition can be used to deposit metals in specific areas and or to pattern metals on various substrates.

Volatile wastes generated during the deposition may be removed from the container 108. Chemical vapor precursors that form the linings often generate waste materials during the deposition. The waste materials may include volatile substituents that are released when the lining portion of the precursor is deposited on the interior surface of the storage container. For example, nickel carbonyl, Ni(CO)₄, may be used as a chemical vapor precursor to deposit a nickel lining. As the Ni atoms are deposited, the carbon monoxide is freed and becomes a volatile waste product in the container. The CO may be removed as the lining is formed.

Some waste products like the CO may be recycled to generate more chemical vapor precursor. These wasted may be recovered from the storage container and purified before being reintroduced to a metal substrate to generate more of the precursor in situ. Recycling waste products this way can significantly reduce the amounts of starting materials needed to form the lining, as well as reducing the costs to dispose the waste.

The method 100 may also include finishing the storage container lining formed by chemical vapor precursor 110. This finishing may include cleaning, annealing, polishing, etc. the deposited lining. Finishing the lining may be optional, especially when the unfinished lining has the required lining properties.

Exemplary Storage Container Coating System

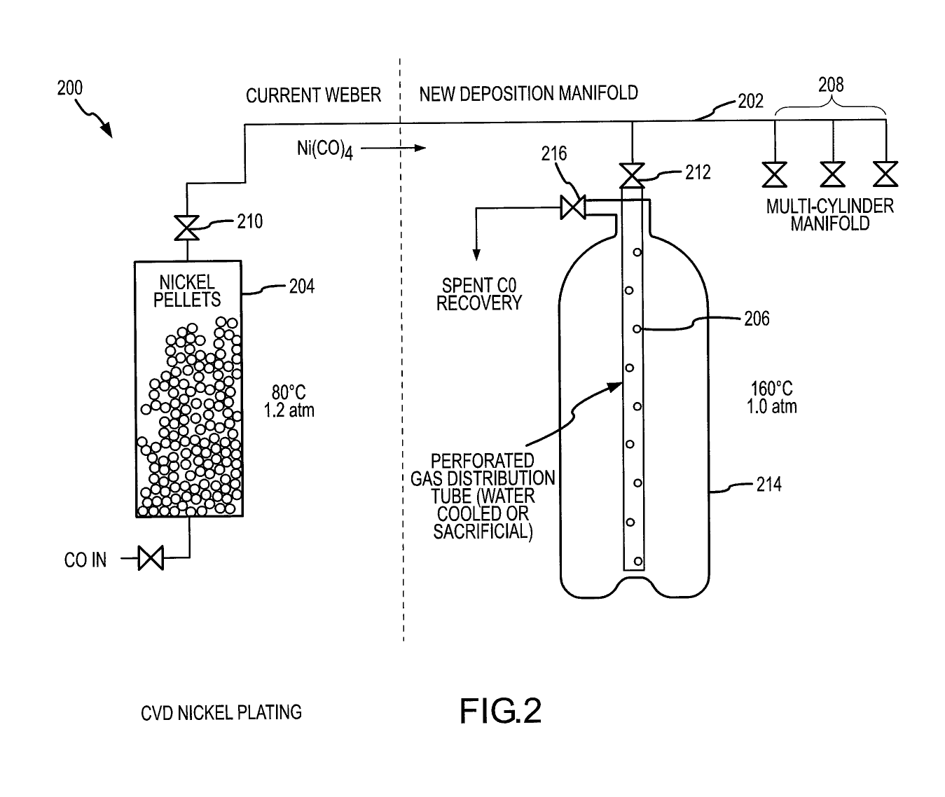

FIG. 2 shows a system 200 for forming metal lining in gas storage containers according to embodiments of the invention. In the illustrated embodiment, system 200 is configured to form a nickel coating on the inside of a gas storage container by chemical vapor deposition of a nickel carbonyl (Ni(CO)₄) precursor.

The system 200 includes a precursor distribution manifold 202 that may be connected to one or more chemical vapor precursor generators 204 and precursor injection assembly 206. The manifold 202 may also include valve controlled inlets 208 for additional gases (not shown) that may be mixed with the chemical vapor precursor.

The manifold 202 may be constructed from various materials, including but not limited to metal compatible with the metal deposition gases, or polymers such as Tefzel, which would limit adhesion of the deposit metal to the manifold. In addition, the manifold 202 can be made from a combination of polymer and metallic materials such that a coating or lining can be placed inside a stainless steel tube in a manner that the lining can be replaced periodically.

In system 200, a coating process may start with the in situ generation of the chemical vapor precursor. The precursor may be generated by supplying a substituent (in this example it's carbon monoxide) to the generator 204 filled with metal pellets (e.g., nickel pellets). As the pellets are heated to about 80° C. in the generator 204 contact with the carbon monoxide at a pressure of about 1 to 2 atmospheres generates the nickel carbonyl Ni(CO)₄ precursor. The precursor enters manifold 202 at valve controlled inlet 210 and exits the manifold at outlet 212. The exiting precursor flows through injection assembly 206 where the precursor can contact the interior surface of gas storage vessel 214. The walls interior walls of the storage vessel 214 may be made of carbon steel that is heated by a heat source (not shown) during the deposition.

As the nickel carbonyl precursor builds up pressure to about 1 atmosphere and the vessel 214 is heated to about 160° C., the precursor begins to breakdown and deposit a coating of nickel metal on the interior surface. Precursor breakdown generates four molecules of CO for each molecule of nickel carbonyl, which can cause a rapid pressure increase inside the cylinder. A pressure controller (not shown) may be coupled to the manifold 202 or assembly 206 to keep the cylinder pressure within a predefined range.

Volatile waste products mostly comprising carbon monoxide may be removed from the vessel 214 through outlet 216 inserted at the top of the vessel. In the embodiment shown, outlet 216 is coupled to the vessel 214. In additional embodiments, one or more exhaust outlets may be formed in the injection assembly 206 and/or manifold 202 (not shown). The waste products may be treated as exhaust, or recycled to provide starting materials for additional chemical vapor precursor.

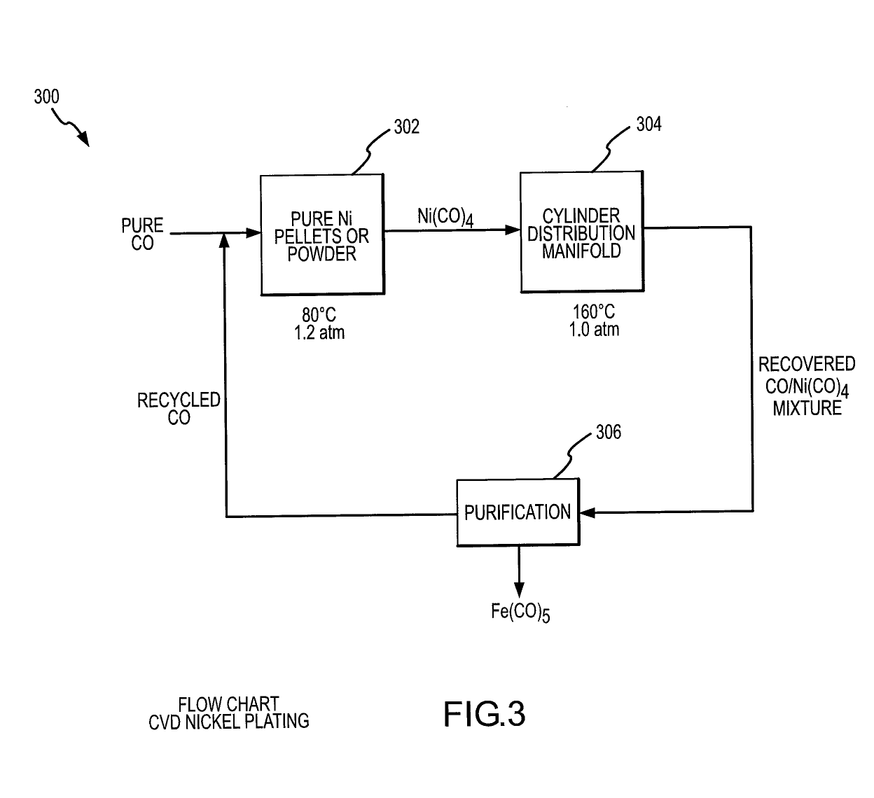

FIG. 3 shows a system 300 for circulating and recycling precursors used to form linings in gas storage containers according to embodiments of the invention. In the illustrated embodiment, system 300 is configured to circulate a nickel carbonyl (Ni(CO)₄) precursor and recycle the carbon monoxide reaction product into additional precursor.

The system 300 includes a precursor generator 302 that supplies precursor to a precursor distribution manifold 304. Waste products generated by the precursor deposition are transported to purifier 306 which may recycle at least a portion of the waste into substitutents that can be sent back to generator 302 to help generate more of the precursor. The purifier 306 may separate the useful substituents (e.g., CO) from contaminants like metals from the storage container walls. In the example shown, iron contaminants in the nickel carbonyl waste products are separated and removed by the purifier 306 as iron carbonyl (Fe(CO)₅).

It should be appreciated that the systems 200 and 300 may be used to form a variety of low-defect, high-purity linings in a storage container, and should not be limited to forming nickel linings from nickel carbonyl. For example, systems 200 and 300 may be used to form gold, platinum, copper, titanium, lead, chromium, iron, tungsten, cobalt, hafnium, zirconium, tantalum, ruthenium, zinc, gallium, indium, germanium, silicon, arsenic and/or silver linings from appropriate chemical vapor precursors.

Exemplary Formation of Tungsten Lining on Carbon Steel Gas Cylinder

A CVD coating process uses tungsten hexafluoride (WF₆) to deposit a tungsten metal lining on the interior of a carbon steel compressed gas cylinder. The tungsten hexafluoride may be high purity (e.g., a purity by weight of 99%, 99.9%, 99.99%, 99.999%, etc.) to produce a high purity tungsten metal lining of a comparable purity level (e.g., a liner having tungsten purity by weight of 99%, 99.9%, 99.99%, 99.999%, etc.). The tungsten deposition operation may start with cylinders that are rated for storing fluids at pressures of, for example 100 psi or more, 1000 psi or more, etc. The cylinders may already be in their final form as opposed to the electroplating coating which is applied before the cylinders are closed, drilled, and tapped. This would eliminate many handling and shipping steps between the cylinder manufacturer and the electroplating facility, and also eliminate problems with electroplate adhesion and residual stresses.

Exemplary Formation of Nickel Lining on Carbon Steel Gas Cylinder

A CVD coating process uses nickel carbonyl to deposit a nickel lining on the interior of carbon steel compressed gas cylinders used for tungsten hexafluoride delivery. The carbonyl process should be considerably cheaper and produce a better quality cylinder lining. Impurities and inclusions in the nickel coating should be considerably reduced. This coating operation starts with cylinders that are already in their final form, as opposed to the electroplating coating which is applied before the cylinders are closed, drilled, and tapped. This would eliminate many handling and shipping steps between the cylinder manufacturer and the electroplating facility, and also eliminate problems with electroplate adhesion and residual stresses. These cylinders would also be appropriate for the delivery of a number of other corrosive gases, including hydrogen halides (e.g., hydrogen chloride, hydrogen bromide, etc.).

Nickel (and to a lesser extent cobalt and iron) readily forms the gaseous compound nickel carbonyl (Ni(CO)₄) when solid nickel is exposed to pure carbon monoxide gas (CO). Typical process conditions are reported below; such conditions are likely adequate but not optimal for our purposes.

Using high purity solid nickel and pure CO at approximately 80° C. and 1 atm pressure, nickel carbonyl is formed in a slightly exothermic process. The Ni(CO)₄ is admitted to the inside of the carbon steel cylinder at 1 atm pressure and 160° C., where the formation reaction is reversed, depositing pure nickel on the cylinder surface and releasing carbon monoxide which is recovered and recycled.

The recovered carbon monoxide will contain nickel carbonyl, as well as iron carbonyl formed as carbon monoxide reacts with exposed iron on the exposed cylinder surface. This iron carbonyl must be removed before the gas can be re-used for nickel deposition.

For simplicity of design, the pressure in the carbonyl formation vessel could be slightly higher than the pressure inside the cylinder so that gas flows through the system without the need for compressors. Similarly, the spent CO may exit the cylinder to a region of even lower pressure. This gas must be recompressed if it is to be recycled.

Having described several embodiments, it will be recognized by those of skill in the art that various modifications, alternative constructions, and equivalents may be used without departing from the spirit of the invention. Additionally, a number of well known processes and elements have not been described in order to avoid unnecessarily obscuring the present invention. Accordingly, the above description should not be taken as limiting the scope of the invention.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a process” includes a plurality of such processes and reference to “the electrode” includes reference to one or more electrodes and equivalents thereof known to those skilled in the art, and so forth.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, acts, or groups.

What is claimed is:

1. A method of coating a storage container for a gas, wherein the method comprises:
supplying tungsten hexafluoride to an interior space of the gas storage container; and
forming a tungsten metal coating on an interior surface that is exposed to the interior space of the storage container, wherein the tungsten coating is formed from the decomposition of the tungsten hexafluoride.

2. The method of claim 1, wherein the tungsten hexafluoride has a purity of about 99%, by weight, or more.

3. The method of claim 1, wherein the tungsten hexafluoride has a purity of about 99.9%, by weight, or more.

4. The method of claim 1, wherein the tungsten hexafluoride has a purity of about 99.99%, by weight, or more.

5. The method of claim 1, wherein the tungsten metal coating has a purity of about 99%, by weight, or more.

6. The method of claim 1, wherein the tungsten metal coating has a purity of about 99.9%, by weight, or more.

7. The method of claim 1, wherein the tungsten metal coating has a purity of about 99.99%, by weight, or more.

8. The method of claim 1, wherein the method further comprises removing gaseous products of the tungsten hexafluoride from the interior of the storage container.

9. The method of claim 8, wherein the gaseous products are recycled to generate more of the chemical vapor precursor.

10. The method of claim 1, wherein the storage contain is a gas cylinder rated to store gas at a pressure of at least 100 psi.

11. The method of claim 1, wherein the storage contain is a gas cylinder rated to store gas at a pressure of at least 1000 psi.

12. The method of claim 1, wherein the gas to be stored in the coated storage container comprises a corrosive gas.

13. The method of claim 1, wherein the gas storage container comprises carbon steel.

14. A gas storage container comprising:
a gas storage vessel with an interior surface that can be exposed to a stored gas; and
a liner formed on the interior surface of the storage vessel, wherein the liner comprises an metal or metal alloy with a purity of about 99%, by weight, or more.

15. The gas storage container of claim 14, wherein the liner comprises an metal or metal alloy with a purity of about 99.9%, by weight, or more.

16. The gas storage container of claim 14, wherein the liner comprises an metal or metal alloy with a purity of about 99.99%, by weight, or more.

17. The gas storage container of claim 14, wherein the gas storage vessel is a metal cylinder.

18. The gas storage container of claim 17, wherein the metal cylinder is rated to store gas at a pressure of 100 psi or more.

19. The gas storage container of claim 17, wherein the metal cylinder is rated to store gas at a pressure of 1000 psi or more.

20. The gas storage container of claim 14, wherein the liner comprises gold, platinum, copper, titanium, lead, chromium, iron, cobalt, or silver.

21. The gas storage container of claim 14, wherein the liner comprises hafnium, zirconium, tantalum, ruthenium, zinc, gallium, indium, germanium, silicon, or arsenic.

22. The gas storage container of claim 14, wherein the liner comprises nickel.

23. The gas storage container of claim 14, wherein the liner comprises tungsten.

24. The gas storage container of claim 14, wherein the stored gas comprises a corrosive gas.

25. The gas storage container of claim 24, wherein the corrosive gas comprises a hydrogen halide.

26. A system for making a tungsten lined gas storage container, the system comprising:
a supply of tungsten hexafluoride;
a precursor injection assembly for transporting the tungsten hexafluoride into an interior space of a gas storage vessel, wherein the tungsten hexafluoride decomposes to deposit the tungsten lining on an interior surface of the storage vessel; and
an exhaust outlet for removing gaseous tungsten hexafluoride deposition products from the interior space of the gas storage vessel.

27. The system of claim 26, wherein the tungsten lining has a tungsten purity of 99%, by weight, or more.

28. The system of claim 26, wherein the tungsten lining has a tungsten purity of 99.9%, by weight, or more.

29. The system of claim 26, wherein the tungsten lining has a tungsten purity of 99.99%, by weight, or more.

30. The system of claim 26, wherein the tungsten lining has a tungsten purity of 99.999%, by weight, or more.

31. The system of claim 26, wherein the precursor injection assembly comprises a perforated tube that extends into the gas storage vessel.

32. The system of claim 26, wherein the precursor injection assembly is coupled to a inert gas source to supply inert gas to the interior space of the gas storage vessel.

33. The system of claim 32, wherein the inert gas comprises helium or argon.

34. The system of claim 26, wherein the exhaust outlet is coupled to a pump to transport the deposition products to a purifier.

35. The system of claim 34, wherein the purifier generates a recycled mixture comprising fluorine.

36. The system of claim 35, wherein the fluorine is transported to a tungsten hexafluoride generator to generate additional WF₆.

37. The system of claim 36, wherein the additional WF₆ is provided to the supply of tungsten hexafluoride.
